(19) United States
(12) Patent Application Publication
(10) Pub. No.: US 2026/0313771 A1
(43) Pub. Date: Oct. 8, 2026

(54) DETERMINING A NON-LINEAR MAPPING OF LIGHT SETTINGS TO LIGHT SOURCES OF A LIGHT STRING

(71) Applicant: SIGNIFY HOLDING B.V., EINDHOVEN (NL)

(72) Inventors: DZMITRY VIKTOROVICH ALIAKSEYEU, EINDHOVEN (NL); ALEKSANDAR OSTOJIC, EINDHOVEN (NL); TOBIAS BORRA, RIJSWIJK (NL)

(21) Appl. No.: 19/483,329

(22) PCT Filed: May 6, 2024
(86) PCT No.: PCT/EP2024/062387

§ 371 Date: Nov. 11, 2025

(30) Foreign Application Priority Data
May 11, 2023 (EP) 23172904.7

(51) Int. Cl. H05B 47/165; H05B 45/10; H05B 45/20; H05B 47/155; H05B 47/16; H05B 47/175; H05B 47/19

(52) U.S. Cl. CPC H05B 47/165; H05B 45/10; H05B 45/20; H05B 47/155; H05B 47/16; H05B 47/19; H05B 47/1965; H05B 47/1985

(57) ABSTRACT

A controller (41) is configured to transmit, to a light string (1), a command to render a light effect. The command specifies one or more colors and/or light intensities. The controller or the light string is configured to receive a first input signal which specifies a first spatial distribution. This first spatial distribution indicates first locations of light sources (11-19) of the light string with respect to an object. The light string is configured to receive the command, determine, in response to the command, a first mapping of light settings to the light sources based on the one or more colors and/or light intensities and further based on the first spatial distribution, and control the light sources to render the light settings according to the first mapping. The first mapping corresponds to a non-linear or other unequal light setting distribution over the light sources.

### FIELD OF THE INVENTION

The invention relates to a light string and a controller.

The invention also relates to a lighting system comprising the light string and the controller.

The invention further relates to a method of controlling a plurality of individually controllable light sources of a light string.

The invention also relates to a computer program product enabling a computer system to perform such a method.

### BACKGROUND OF THE INVENTION

The quantity of static light effects and dynamic light effects that can be rendered by connected lighting systems continues to increase. For example, the number of dynamic effects supported by the Hue system has been growing steadily over last couple of years, e.g., natural effects like candle and fire, dynamic scenes comprising slow moving palette colors, wellbeing effects like wake up and go to sleep, and effects related to the music and light integration. These effects are typically rendered on devices with a single light source (e.g., bulbs) or pixelated lighting devices (e.g., the Hue gradient product range).

When rendering light effects on light strings, which comprise a large number of small, direct view, light sources, rendering light effects in the intended manner becomes more challenging. Twinkly light strings can render light effects in the intended manner by letting the user use Twinkly's app, which uses the camera of the user's phone to scan the user's light string(s), map the position of each LED, and turn them into a virtual display. A drawback of this approach is that transmitting a light setting per light source/pixel consumes considerable bandwidth when the number of light sources/pixels is large, while low-power wireless protocols such as Zigbee have limited bandwidth.

US 2021/0092817 A1 discloses a method of generating a dynamic light effect on a light source array that solves this problem. The method comprises obtaining or generating a vector, wherein the vector has a plurality of behavior parameters comprising at least a speed and a direction, and the vector has one or more appearance parameters comprising at least a color and/or a brightness, mapping the vector onto the light source array over time according to the behavior parameters of the vector, and controlling the light output of the plurality of light sources over time according to the mapping of the vector onto the light source array and according to the appearance parameters of the vector.

A drawback of the method of US 2021/0092817 A1 is that since light strings can be used in different configurations, the distribution of the light sources might not be equal across the height of the object, e.g. a Christmas tree. This can impact the rendering of static and dynamic light effects, where in the case of static light effects some colors might be more prominent than intended, and in the case of dynamic light effects some parts of the light source might be perceived as more or less dynamic than other parts. For example, a moving gradient effect on a Christmas tree could appear slower at the bottom of the tree in comparison to the top of the tree.

### SUMMARY OF THE INVENTION

It is a first object of the invention to provide a lighting system, which can be used to control light sources of a light string to render a light effect in the manner it is intended while limiting bandwidth usage.

It is a second object of the invention to provide a method, which can be used to control light sources of a light string to render a light effect in the manner it is intended while limiting bandwidth usage.

In a first aspect of the invention, a lighting system comprises a light string and a controller for controlling said light string, said controller comprising at least one receiver, at least one transmitter, and at least one processor, and said light string comprising a plurality of individually controllable light sources, at least one further receiver, and at least one further processor, said at least one processor of said controller being configured to transmit, via said at least one transmitter, to said light string, a command to render a light effect on said light string, said command specifying one or more colors and/or one or more light intensities, and said at least one further processor of said light string being configured to receive said command via said at least one further receiver, determine, in response to said command, a first mapping of light settings to said light sources based on said one or more colors and/or said one or more light intensities, and control said light sources to render said light settings according to said first mapping.

Said at least one processor or said at least one further processor is configured to receive a first input signal, said first input signal specifying a first spatial distribution, said first spatial distribution indicating first locations of said light sources with respect to an object, and said at least one further processor is configured to determine said first mapping further based on said first spatial distribution, said first mapping corresponding to a non-linear or other unequal light setting distribution over said light sources.

By determining the mapping based on the one or more colors and/or the one or more light intensities specified in the command and a spatial distribution which indicates locations of the light sources of the light string with respect to an object, the command requires little bandwidth and the light effect can be rendered in the manner it is intended. The light effect can be rendered in the manner it is intended, because the mapping can be determined to ensure a perceived equal spatial and/or temporal light distribution across the whole height of the object. This is achieved by using a non-linear or other unequal light setting distribution over the light sources for at least a first spatial distribution of the light sources.

The object may be cone-shaped or sphere-shaped or hourglass-shaped, for example. The object may be a Christmas tree, for example. The command may specify the one or more colors and/or the one or more light intensities by specifying one or more color values and/or one or more intensity values or by specifying a light scene identifier associated with one or more color values and/or one or more intensity values, for example. The light string does not need to be linear. For example, the light string may have a T like shape. The light sources of the light string may be distributed over multiple separate components which may be connected by a user. For example, a user may be able to connect multiple linear strings to another linear string to obtain a (composite) string with a T like shape.

In a linear distribution of the light settings over the light sources, each color or light intensity is mapped to (approximately) the same number of light sources. In conventional light strings, such a linear distribution is used for a (color and/or intensity) gradient effect and for a flag effect independent of the locations of the light sources. In the flag effect, only the specified colors are rendered and none of the light sources render interpolated colors. With the above-described system, a non-linear light setting distribution may be used for at least a first spatial distribution of the light sources. The first spatial distribution may be a linear or non-linear spatial distribution of the light sources. However, the first spatial distribution is typically an unequal/uneven spatial distribution of the light sources in which the density of light sources varies across the length of the string in respect to the object.

Not all light effects comprise a spatial light setting distribution. Certain light effects only comprise a temporal light setting distribution. For example, in a sparkle effect, each light source renders a certain color with a certain probability and in a blinking effect, each light source renders a certain color with a certain transition speed. The transition speed defines the period during which the light source is off. In conventional light strings, the same probability or transition speed is used for all light sources and therefore an equal distribution of light settings over the light sources is used. With the above-described system, an unequal light setting distribution may be used for at least a first spatial distribution of the light sources. For example, the light effect rendering probability or the light effect transition speed may differ per light source or per group of light sources.

Said at least one processor or said at least one further processor may be configured to receive a second input signal, said second input signal specifying a second spatial distribution, said second spatial distribution indicating second locations of said light sources with respect to a second object, and said at least one further processor may be configured to determine a second mapping of light settings to said light sources based on said one or more colors and/or said one or more light intensities and further based on said second spatial distribution, said second mapping corresponding to a linear or other equal light setting distribution over said light sources, and control said light sources to render said light settings according to said second mapping. Said second object may be cylinder-shaped or rectangle-shaped, for example.

Said lighting system may comprise a further light string, said further light string comprising another plurality of individually controllable light sources, at least one other receiver, and at least one other processor configured to receive, via said at least one other receiver, a further command to render said light effect on said further light string, said further command specifying said one or more colors and/or said one or more light intensities, determine, in response to said further command, a further mapping of light settings to said other light sources based on said one or more colors and/or said one or more light intensities, said further mapping corresponding to a linear or other equal light setting distribution over said other light sources, and control said other light sources to render said light settings according to said further mapping.

The further light string may be configured in a similar manner as the light string and may determine a mapping which corresponds to a linear or other equal light setting distribution over its light sources, because its light sources are evenly distributed over the height of the object, e.g. when the object is cylinder-shaped or rectangular-shaped.

Alternatively, the further light string may not be configured to determine a mapping based on a spatial distribution which indicates locations of its light sources with respect to an object, e.g. may be a conventional light string.

Said first spatial distribution may be represented by one or more of: the shape of said light string with respect to said object, the shape of said object, and a quantity of light sources per part of said object and said at least one further processor may be configured to determine said first mapping based on at least one of: said shape of said light string, said shape of said object, and said quantity of light sources per part of said object. This spatial distribution is indicative of the locations of the light sources with respect to the object and may be used, for example, if more accurate location information is not available.

For instance, the object may be partitioned into a number of parts of the same height. A spatial distribution may specify, for example, that of a light string with 108 lights sources 48 light sources are placed on a first part of an object, 36 light sources are placed on a second part of an object, and 24 light sources are placed on a third part of the object. Light sources in the same part do not need to render the same light setting. For example, ten groups that render the same light setting may be determined based on a spatial distribution that specifies three parts.

The shape of the object may also be used as indication of the location of the light sources, e.g. if the object has a regular shape. The object may be a Christmas tree, for example. If the width-to-height ratio of the object is not known, an average width-to-height ratio may be assumed. If more accurate locations of the light sources are not known, it may also be assumed that the light string has been wrapped around the object in a typical manner, although it is preferable to take the shape of the light string with respect to the object into account in this case.

Said one or more colors may comprise a plurality of colors, said light effect may comprise a spatial color distribution, and said at least one further processor may be configured to determine said first mapping based on said plurality of colors and said first spatial distribution, said first mapping corresponding to a non-linear color distribution over said light sources. Said light effect may be a color gradient light effect, for example.

Said light effect may comprise a temporal light setting distribution and said at least one further processor may be configured to determine said first mapping based on said first spatial distribution such that a light effect transition speed per light source or a light effect rendering probability per light source depends on said first spatial distribution. Said light effect may be a sparkle effect or a blink effect, for example.

Said at least one processor or said at least one further processor may be configured to obtain information indicative of an accuracy of said first spatial distribution and/or a reliability of said first spatial distribution, and said at least one further processor may be configured to determine said first mapping and/or a level of dynamicity of said light effect based on said accuracy and/or said reliability.

If the spatial distribution is not (very) accurate (e.g. the object size is unknown or further configuration parameters are unknown), aspects of the light effect may be masked to minimize apparent artefacts. This masking may be achieved, for example, by reducing the level of dynamicity of the light effect and/or by adjusting the mapping to reduce differences between light settings of successive light sources. The level of dynamicity may be reduced, for example, by reducing how often a light source can render a different light setting. The mapping may be adjusted, for example, by increasing smoothing parameters or by increasing the pixel size of effects (i.e. by using larger groups that render the same light setting), thereby making spatial effects less apparent. Not only spatial smoothing may be increased, but also temporal smoothing (which causes smaller differences between successive light settings rendered by the same light source).

In a second aspect of the invention, a light string for use in the lighting system comprises said plurality of individually controllable light sources, said at least one further receiver, and said least one further processor, wherein said at least one further processor is configured to receive said first input signal, said first input signal specifying said first spatial distribution, said first spatial distribution indicating said first locations of said light sources with respect to said object, receive said command via said at least one further receiver, determine, in response to said command, said first mapping of light settings to said light sources based on said one or more colors and/or said one or more light intensities and further based on said first spatial distribution, said first mapping corresponding to a non-linear or other unequal light setting distribution over said light sources, and control said light sources to render said light settings according to said first mapping.

In a third aspect of the invention, a controller for use in the lighting system comprises said at least one receiver, said at least one transmitter, and said least one processor, wherein said at least one processor is configured to receive said first input signal, said first input signal specifying said first spatial distribution, said first spatial distribution indicating said first locations of said light sources of said light string with respect to said object, determine a first mapping instruction for said light string based on said first spatial distribution, and transmit, via said at least one transmitter, to said light string, said first mapping instruction and said command to render said light effect on said light string to cause said at least one further processor of said light string to determine said first mapping based on said one or more colors and/or said one or more light intensities and further based on said first spatial distribution, said first mapping corresponding to a non-linear or other unequal light setting distribution over said light sources.

Said first mapping instruction may specify a light setting per light source for only a subset of said light sources, a light effect transition speed per light source for all of said light sources, a light effect transition speed per light source for only a subset of said light sources, a light effect rendering probability per light source for all of said light sources, a light effect rendering probability per light source for only a subset of said light sources, or multiple groups of said light sources, each of said multiple groups rendering a different light setting and all light sources of a single group rendering a same light setting.

As a first example, the mapping instruction may specify that on a string with 100 pixels, color 1 should be rendered by pixel 1 (i.e. the first pixel) of the string, color 2 by pixel 20, color 3 by pixel 50, and color 4 by pixel 100 (i.e. the last pixel). The light string may then optionally interpolate these values for the intermediate pixels. As a second example, the mapping instruction may specify that on a string with 100 pixels, the groups of pixels 1-4, pixels 5-9, pixels 10-16, pixels 17-24, pixels 25-33, pixels 34-43, pixels 44-56,pixels 57-70, pixels 71-85, and pixels 85-100 should each render a different light setting.

This light string may then render ten different colors, e.g. four user-specified colors and six interpolated colors on the ten groups.

This substantially reduces the required bandwidth compared to transmitting one or more commands that specify a color per light source. Even specifying a light effect transition speed per light source for all of said light sources, e.g. for a blinking effect, or specifying a light effect rendering probability per light source for all of said light sources, e.g. for a sparkle effect, would reduce the required bandwidth, as this would only need to be done at the start of the rendering of the light effect. Transmitting a command that specifies a color per light source each time a color needs to be changed requires much more bandwidth. However, by specifying the light effect transition speed or the light effect rendering probability per light source for only a subset of the light sources, even less bandwidth is required.

As a third example, the mapping instruction may specify that on a string with 100 pixels, pixel 1 (i.e. the first pixel) of the string changes fast, pixel 20 changes slower, pixel 50 changes even slower and pixel 100 (i.e. last pixel) changes slowest over time. The light string may then optionally interpolate these values for the intermediate pixels.

In a fourth aspect of the invention, a method of controlling a plurality of individually controllable light sources of a light string comprises receiving a first input signal, said first input signal specifying a first spatial distribution, said first spatial distribution indicating first locations of said light sources with respect to an object, and transmitting, from a controller to said light string, a command to render a light effect on said light string, said command specifying one or more colors and/or one or more light intensities. The method further comprises determining, at said light string, in response to said command, a first mapping of light settings to said light sources based on said one or more colors and/or said one or more light intensities and further based on said first spatial distribution, said first mapping corresponding to a non-linear or other unequal light setting distribution over said light sources, and controlling, at said light string, said light sources to render said light settings according to said first mapping. Said method may be performed by software running on a programmable device. This software may be provided as a computer program product.

Moreover, one or more computer programs for carrying out the method steps described herein (e.g. a computer program for carrying out the method steps to be carried out by the light string and/or a computer program for carrying out the method steps to be carried out by the controller), as well as a non-transitory computer readable storage-medium storing the one or more computer programs are provided. A computer program may, for example, be downloaded by or uploaded to an existing device or be stored upon manufacturing of these systems.

As will be appreciated by one skilled in the art, aspects of the present invention may be embodied as a device, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java(TM), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of devices, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### BRIEF DESCRIPTION OF THE DRAWINGS

These and other aspects of the invention are apparent from and will be further elucidated, by way of example, with reference to the drawings, in which:

FIG. 1 is a block diagram of an embodiment of the system;

FIG. 2 shows examples of linear and non-linear light setting distributions over light sources of a light string;

FIG. 3 is a flow diagram of a first embodiment of the method;

FIG. 4 is a flow diagram of a second embodiment of the method;

FIG. 5 is a flow diagram of a third embodiment of the method;

FIG. 6 is a flow diagram of a fourth embodiment of the method; and

FIG. 7 is a block diagram of an exemplary data processing system for performing the method of the invention.

Corresponding elements in the drawings are denoted by the same reference numeral.

### DETAILED DESCRIPTION OF THE EMBODIMENTS

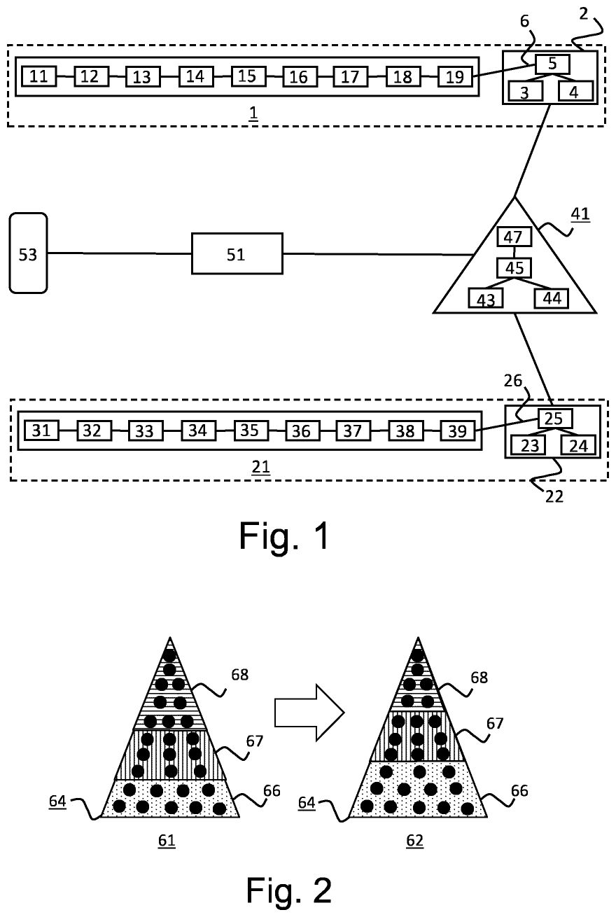

FIG. 1 shows an embodiment of the lighting system. The lighting system comprises a (light) controller 41, a light string 1, and a light string 21. The controller 41 may be a Hue bridge, for example. The light string 1 comprises nine individually controllable light sources 11-19. The light string 21 comprises nine individually controllable light sources 31-39. Different light sources of the light strings may have different light settings (on/off, color, intensity). In the embodiment of FIG. 1, each light source comprises a single light element, e.g. a direct emitting or phosphor converted LED. In an alternative embodiment, one or more of the light sources comprise multiple light elements. In practice, light strings will typically have many more than nine light sources.

In the embodiment of FIG. 1, the light strings 1 and 21 can be controlled via controller 41, e.g. using Zigbee technology. The controller 41 is connected to a wireless LAN access point 51, e.g. via Ethernet or Wi-Fi. A mobile device 53 is also connected to the wireless LAN access point 51, e.g. via Wi-Fi. Mobile device 53 may be a mobile phone, a tablet or a smart watch, for example. A user may be able to use an app running on mobile device 53 to control light strips 1 and 21 via the wireless LAN access point 51 and the controller 41.

To simplify control of pixelated lighting devices, the app does not ask the user to specify a color per light source of the light strip, but instead asks the user to specify a limited number of colors and/or light intensities, e.g. three. The app may, for example, use a limited number of colors specified by the user to create a color gradient. Alternatively, this limited number of colors and/or light intensities may be extracted from an image selected by the user, for example.

The light string 1 comprises a control box 2, light sources 11-19, and a control interface 6 between the control box 2 and the light sources 11-19. The control box 2 comprises a receiver 3, a transmitter 4, and a processor 5. The controller 41 comprises a receiver 43, a transmitter 44, a processor 45, and memory 47. The processor 45 or the processor 5 is configured to receive a first input signal which specifies a first spatial distribution. The first spatial distribution indicates first locations of the light sources 11-19 with respect to an object. The object may be cone-shaped or sphere-shaped or hourglass-shaped, for example. The object may be a Christmas tree, for example.

The processor 45 is configured to transmit, via the transmitter 44, to the light string 1, a command to render a light effect on the light string 1. The command specifies one or more colors and/or one or more light intensities. The processor 5 is configured to receive the command via the receiver 3, determine, in response to the command, a first mapping of light settings to the light sources 11-19 based on the one or more colors and/or the one or more light intensities and further based on the first spatial distribution, and control the light sources 11-19 to render the light settings according to the first mapping. The first mapping corresponds to a non-linear or other unequal light setting distribution over the light sources 11-19.

In a linear distribution of the light settings over the light sources, each color or light intensity is mapped to (approximately) the same number of light sources. In conventional light strings, such a linear distribution is used for a (color and/or intensity) gradient effect and for a flag effect independent of the locations of the light sources. In the flag effect, only the specified colors are rendered and none of the light sources render interpolated colors. The light string 1 may use a non-linear light setting distribution for at least the first spatial distribution of the light sources, e.g. if the light effect is a gradient effect or flag effect.

Not all light effects comprise a spatial light setting distribution. Certain light effects only comprise a temporal light setting distribution. For example, in a sparkle effect, each light source renders a certain color with a certain probability and in a blinking effect, each light source renders a certain color with a certain transition speed. The transition speed defines the period during which the light source is off. In conventional light strings, the same probability or transition speed is used for all light sources and therefore an equal distribution of light settings over the light sources is used. The light string 1 may use an unequal light setting distribution for at least the first spatial distribution, e.g. if the light effect is a sparkle effect or a blinking effect. For example, the light effect rendering probability or the light effect transition speed may differ per light source or per group of light sources.

The first spatial distribution may be represented, for example, by one or more of: the shape of the light string 1 with respect to the object, the shape of the object, and a quantity of light sources per part of the object. The processor 5 may be configured to determine the first mapping based on the first spatial distribution by determining the first mapping based the shape of the light string 1, the shape of the object, and/or the quantity of light sources per part of the object.

For instance, the object may be partitioned into a number of parts of the same height. A spatial distribution may specify, for example, that of a light string with 108 lights sources 48 light sources are placed on a first part of an object, 36 light sources are placed on a second part of an object, and 24 light sources are placed on a third part of the object. Light sources in the same part do not need to render the same light setting. For example, ten groups that render the same light setting may be determined based on a spatial distribution that specifies three parts.

The shape of the object may also be used as indication of the location of the light sources, e.g. if the object has a regular shape. The object may be a Christmas tree, for example. If the width-to-height ratio of the object is not known, an average width-to-height ratio may be assumed. If more accurate locations of the light sources are not known, it may also be assumed that the light string has been wrapped around the object in a typical manner, although it is preferable to take the shape of the light string with respect to the object into account in this case.

The processor 45 or the processor 5 are further configured to receive a second input signal which specifies a second spatial distribution. The second spatial distribution indicates second locations of the light sources 11-19 with respect to a second object. The processor 5 is further configured to determine a second mapping of light settings to the light sources 11-19 based on the one or more colors and/or the one or more light intensities and further based on the second spatial distribution. The second mapping corresponds to a linear or other equal light setting distribution over the light sources 11-19.

The processor 5 is configured to control, via control interface 6, the light sources 11-19 to render the light settings according to the first mapping if the first input signal is received and control the light sources 11-19 to render the light settings according to the second mapping if the second input signal is received.

FIG. 2 shows examples of linear and non-linear light setting distributions over light sources of a light string. In the examples of FIG. 2, a light string is wrapped around a Christmas tree and the light effect rendered by the light string is a flag effect with three colors. In example 61, the light string uses a conventional linear light setting distribution over light sources of a light string even though it is not appropriate in this case. A top segment 68 of the Christmas tree renders the first color, a middle segment 67 of the Christmas tree renders the second color, and a bottom segment 66 of the tree renders the third color. Unlike with a color gradient effect, all light sources only render one of the specified colors and do not render interpolated colors.

In example 61, each segment of the tree comprises (approximately) the same quantity of light sources. In example 61, nine light sources are visible in each segment. Since a Christmas tree is larger at the bottom than at the top, this results in a smaller portion of the height of the object being illuminated with the third color than with the other colors and a larger portion of the height of the object being illuminated with the first color than with the other colors. As a result, the first color is the most prominent and the third color is the least prominent, which is not the intended effect. The mapping used by the light string in example 61 might be appropriate if the light string is wrapped around a cylinder-shaped or rectangular-shaped object, but not if the light string is wrapped around a cone-shaped or sphere-shaped or hourglass-shaped object.

In example 62, the light string use a more appropriate mapping. This light string is configured in a similar manner as light string 1 of FIG. 1, but has more light sources/pixels. In example 62, the light string uses a non-linear color distribution over the light sources and the segments that render a single color are different compared to the segments of example 61.

In example 62, each segment of the tree comprises a different quantity of light sources. The height of each segment is approximately the same, which results in each color have the same or a similar prominence. The bottom segment 66 comprises more light sources than the other segments, because the width of the object is largest at the bottom. The top segment 68 comprises less light sources than the other segments, because the width of the object is smallest at the top.

The intelligence that causes the appropriate mapping to be used may reside primarily in the controller 41 or primarily in the light string 1. In a first implementation, the processor 5 of the light string is configured to receive the first input signal which specifies the first spatial distribution, determine, in response to the command, the first mapping of light settings to the light sources based on the one or more colors and/or the one or more light intensities and further based on the first spatial distribution, and control the light sources to render the light settings according to the first mapping.

In a second implementation, the processor 45 of the controller 41 is configured to receive the first input signal which specifies the first spatial distribution, determine a first mapping instruction for the light string 1 based on the first spatial distribution, and transmit, via the transmitter 44, the first mapping instruction and the command to the light string 1 to cause the processor 5 of the light string 1 to determine the first mapping based on the one or more colors and/or the one or more light intensities and further based on the first spatial distribution.

As a first example, the mapping instruction may specify that on a string with 100 pixels, color 1 should be rendered by pixel 1 (i.e. the first pixel) of the string, color 2 by pixel 20, color 3 by pixel 50, and color 4 by pixel 100 (i.e. the last pixel). The light string may then optionally interpolate these values for the intermediate pixels. As a second example, the mapping instruction may specify that on a string with 100 pixels, the groups of pixels 1-4, pixels 5-9, pixels 10-16, pixels 17-24, pixels 25-33, pixels 34-43, pixels 44-56, pixels 57-70, pixels 71-85, and pixels 85-100 should each render a different light setting.

This light string may then render ten different colors, e.g. four user-specified colors and six interpolated colors on the ten groups.

As a third example, the mapping instruction may specify that on a string with 100 pixels, pixel 1 (i.e. the first pixel) of the string changes fast, pixel 20 changes slower, pixel 50 changes even slower and pixel 100 (i.e. last pixel) changes slowest over time. The light string may then optionally interpolate these values for the intermediate pixels.

The light string 21 of FIG. 1 comprises a control box 22, light sources 31-39, and a control interface 26 between the control box 22 and the light sources 31-39. The control box 22 comprises a receiver 23, a transmitter 24, and a processor 25. The processor 25 is configured to receive, via the receiver 23, a further command to render the light effect on the further light string 21. The further command specifies the same one or more colors and/or the one or more light intensities as the command. The command and the further command may differ only in terms of the destination address, for example.

The processor 25 is further configured to determine, in response to the further command, a further mapping of light settings to the light sources 31-39 based on the one or more colors and/or the one or more light intensities, and control the light sources 21-29 to render the light settings according to the further mapping. The further mapping corresponds to a linear or other equal light setting distribution over the light sources 31-39.

The processor 25 may be configured in a similar manner as processor 5 and may determine the further mapping, because the light sources 31-39 are evenly distributed over the height of the object, e.g. when the object is cylinder-shaped or rectangular-shaped. Alternatively, the processor 25 may not be configured to determine a mapping based on a spatial distribution which indicates locations of the light sources 31-39 with respect to an object.

In the embodiment of the light strings 1 and 21 shown in FIG. 1, the light strings each comprises one processor. In an alternative embodiment, the light string 1 and/or the light string 21 comprises multiple processors. The processor of a light string may be a general-purpose processor or an application-specific processor. The receiver and the transmitter of a light string may use one or more wireless communication technologies. e.g. Zigbee, for communicating with the controller 41. In an alternative embodiment, multiple receivers and/or multiple transmitters are used instead of a single receiver and a single transmitter.

In the embodiment shown in FIG. 1, a separate receiver and a separate transmitter are used. In an alternative embodiment, the receiver and the transmitter of a light string are combined into a transceiver. The light strings may comprise other components typical for a lighting device such as a power connector. The invention may be implemented using a computer program running on one or more processors.

In the embodiment of the controller 41 shown in FIG. 1, the controller 41 comprises one processor 45. In an alternative embodiment, the controller 41 comprises multiple processors. The processor 45 of the controller 41 may be a general-purpose processor, e.g. ARM-based, or an application-specific processor. The processor 45 of the controller 41 may run a Unix-based operating system for example. The memory 47 may comprise one or more memory units. The memory 47 may comprise one or more hard disks and/or solid-state memory, for example.

The receiver 43 and the transmitter 44 may use one or more wired or wireless communication technologies such as Zigbee to communicate with the light strings 1 and 21 and Ethernet to communicate with the wireless LAN access point 51, for example. In an alternative embodiment, multiple receivers and/or multiple transmitters are used instead of a single receiver and a single transmitter. In the embodiment shown in FIG. 1, a separate receiver and a separate transmitter are used. In an alternative embodiment, the receiver 43 and the transmitter 44 are combined into a transceiver. The controller 41 may comprise other components typical for a (light) controller such as a power connector. The invention may be implemented using a computer program running on one or more processors.

In the embodiment of FIG. 1, the controller is located near the lights strings 1 and 21. In an alternative embodiment, the controller is a cloud computer. In this alternative embodiment, the lights strings 1 and 21 may be directly connected to the wireless LAN access point 51, for example.

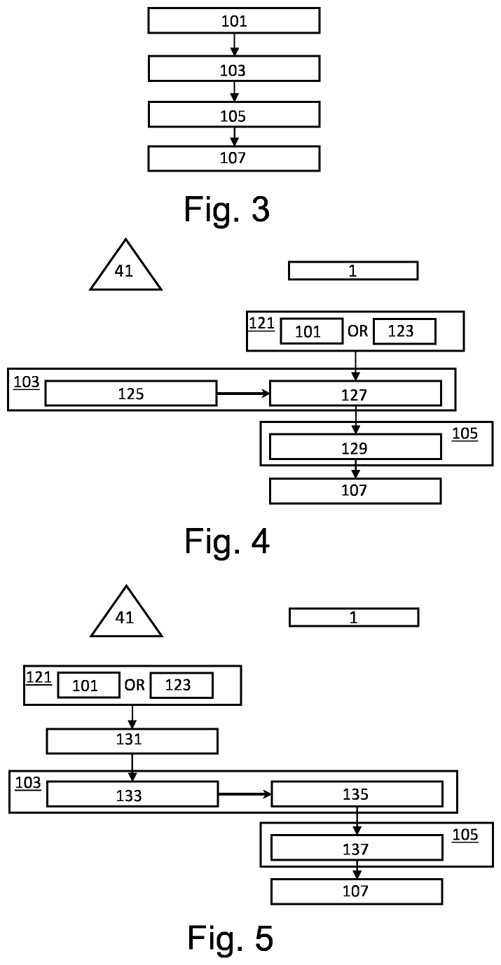

A first embodiment of the method of controlling a plurality of individually controllable light sources of a light string is shown in FIG. 3. The method may be performed jointly by the controller 41 and the light string 1 of FIG. 1, for example.

A step 101 comprises receiving a first input signal which specifies a first spatial distribution. The first spatial distribution indicates first locations of the light sources with respect to an object. The object may be cone-shaped or sphere-shaped or hourglass-shaped, for example. The spatial distribution may be determined by determining relative locations of each individual light source via a camera, for example.

Alternatively, approximate relative locations of the light sources may be estimated based on user input. For example, the user may input the shape, the length, and the width of an object, e.g. a Christmas tree, the length of the light string, and the quantity of light sources on the light string. In most cases, the exact location of each light source is not required. Alternatively, the locations of the lights sources may be determined by embedding a local sensor in each light sources and detecting proximity between light sources based on the sensor data from the local sensors.

A step 103 comprises transmitting, from a controller to the light string, a command to render a light effect on the light string. The command specifies one or more colors and/or one or more light intensities. These one or more colors and/or these one or more light intensities may be specified by a user or may be determined by analyzing audio content, image content, and/or video content, for example.

A step 105 comprises determining, at the light string, in response to the command, a first mapping of light settings to the light sources based on the one or more colors and/or the one or more light intensities and further based on the first spatial distribution. The first mapping corresponds to a non-linear or other unequal light setting distribution over the light sources. Optionally, step 105 may comprise first determining, based on the first spatial distribution, whether the use of a linear or other equal light setting distribution over the light sources would result in an undesired effect. Perceptual color distance between specified colors may be taken into account in step 105.

If the light effect comprises a spatial color distribution and the command specifies a plurality of colors, step 105 may comprise determining the first mapping based on the plurality of colors and the first spatial distribution, and the first mapping then corresponds to a non-linear color distribution over the light sources. The light effect may be a color gradient light effect and/or a spatial color distribution which moves over the light sources, for example.

If the light effect comprises a temporal light setting distribution, step 105 may comprise determining the first mapping based on the first spatial distribution such that a light effect transition speed per light source or a light effect rendering probability per light source depends on the first spatial distribution. The light effect may be a sparkle effect or a blink effect, for example.

The benefit of using a non-linear or other unequal light setting distribution over the light sources for the first spatial distribution, which is typically an unequal/uneven spatial distribution of the light sources in respect of the object, depends on the type of the light effect. The benefit will likely be greatest in the case of light effects that rely on a specific spatial distribution of colors (e.g. gradient) or on a temporal distribution combined with a spatial distribution (e.g., moving gradient, or any other “moving” effect). The benefit will likely be smaller in case of a more random effects like a sparkle effect. However, there may also be benefit for stochastic effects. For example, in the case of a Christmas tree light string, due to higher number of light sources at the bottom of the tree, a sparkle effect might be perceived as concentrated too much at the bottom and not enough at the top of the tree if an equal light setting distribution over the light sources would be used.

By determining the mapping based on the spatial distribution, undesired effects other than the unequal spatial distribution of light sources may also be addressed. For example, another undesired effect due to the light source distribution may be “sparse distribution”, where there are too few light sources for the size of the object. In this case, there will be a lot of distant colors that do not look perceptually pleasing. This undesired effect may be addressed by reducing the color distance between rendered colors.

The mapping determined in step 105 may be used to equalize static light effects and/or dynamic light effects. A static light effect only comprises a spatial light setting distribution. A dynamic light effects comprise a spatial light setting distribution and/or a temporal light setting distribution. Adjustments of static light effects may depend on the desired light setting distribution. In the case of a color gradient effect rendered on a Christmas tree, the intended effect is normally that each color has the same perceived height. However, due to the unequal distribution of the light sources, the colors rendered on the top of the tree will appear to be larger in height (see example 61 of FIG. 2). The mapping may therefore be determined such that closer to the top of the tree, each color is rendered with a lower number of light sources (see example 62 of FIG. 2).

Similar to static light effects, adjustment of dynamic light effects may depend on desired color and dynamics distribution. For stochastic light effects like sparkle, the adjustment could be done, for example, by reducing the probability of rendering the effect in dense areas, leading to same density of light sources that render the effect across the height of the object. For spatial dynamic effects, the adjustment may be similar to the adjustment of static light effects. For example, in the case of a moving gradient effect, the quantity of light sources rendering a single color may be increased in dense areas and reduced in less dense areas, such that the height of each color would appear the same.

If the first spatial distribution is represented by the shape of the light string with respect to the object, the shape of the object, and/or a quantity of light sources per part of the object, step 105 may comprise determining the first mapping based the shape of the light string, the shape of the object, and/or the quantity of light sources per part of the object. A step 107 comprises controlling, at the light string, the light sources to render the light settings according to the first mapping determined in step 105. Additionally, one or more steps of one or more of the embodiments of FIGS. 4, 5, and 6 may be added to the embodiment of FIG. 3.

A second embodiment of the method of controlling a plurality of individually controllable light sources of a light string is shown in FIG. 4. A step 121 is performed by a light string 1. Step 121 comprises receiving an input signal. Step 121 comprises receiving a first input signal in step 101 or a second input signal in a step 123. The first input signal specifies a first spatial distribution. The first spatial distribution indicates first locations of a plurality of individually controllable light sources of the light string 1 with respect to an object. The second input signal specifies a second spatial distribution. The second spatial distribution indicates second locations of the light sources with respect to a second object.

A step 125 is performed by a controller 41. Step 125 comprises transmitting, to the light string, a command to render a light effect on the light string. The command specifies one or more colors and/or one or more light intensities. A step 127 is performed by the light string 1. Step 127 comprises receiving the command from the controller 41.

A step 129 is performed by the light string 1. Step 129 comprises determining, in response to the command, a mapping of light settings to the light sources of the light string based on the one or more colors and/or the one or more light intensities. If the first input signal was received in step 121, a first mapping of light settings to the light sources is determined in step 129. This first mapping is further based on the first spatial distribution and corresponds to a non-linear or other unequal light setting distribution over the light sources. This first mapping may be determined if the object is cone-shaped or sphere-shaped or hourglass-shaped, for example.

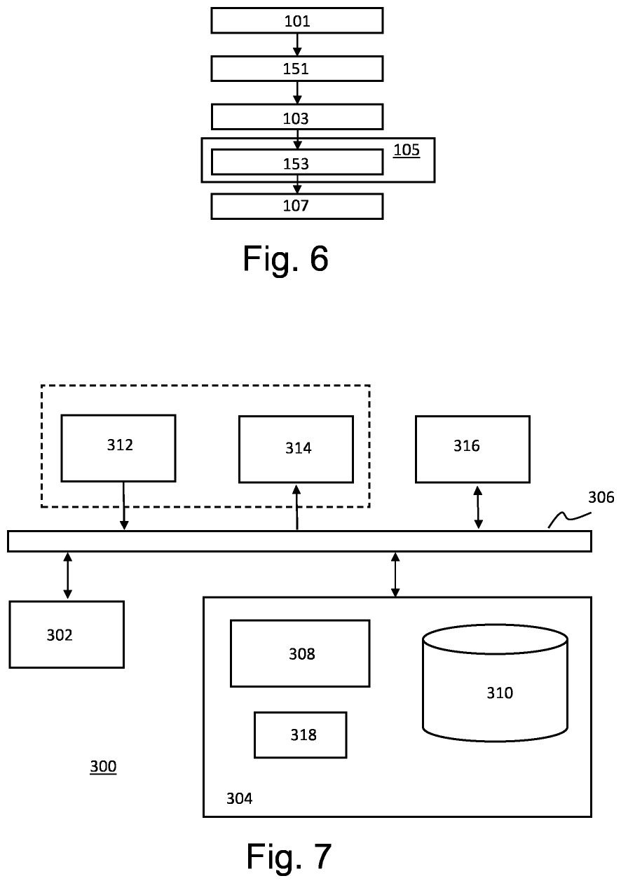

If the second input signal was received in step 121, a second mapping of light settings to the light sources is determined in step 129. This second mapping is further based on the second spatial distribution and corresponds to a linear or other equal light setting distribution over the light sources. This second mapping may be determined if the object is cylinder-shaped or rectangle-shaped, for example. Step 107 is performed by the light string 1. Step 107 comprises controlling the light sources to render the light settings according to the mapping determined in step 129. Additionally, steps 151 and 153 of the embodiment of FIG. 6 may be added to the embodiment of FIG. 4.

A third embodiment of the method of controlling a plurality of individually controllable light sources of a light string is shown in FIG. 5. Step 121 is performed by a controller 41. Step 121 comprises receiving an input signal. Step 121 comprises receiving a first input signal in step 101 or a second input signal in step 123. The first input signal specifies a first spatial distribution. The first spatial distribution indicates first locations of a plurality of individually controllable light sources of the light string 1 with respect to an object. The second input signal specifies a second spatial distribution. The second spatial distribution indicates second locations of the light sources with respect to a second object.

A step 131 is performed by the controller 41. Step 131 comprises determining a mapping instruction for the light string based on the spatial distribution specified in the input signal received in step 121. If the first input signal was received in step 121, a first mapping instruction is determined in step 131. This first mapping instruction is determined based on the first spatial distribution. If the second input signal was received in step 121, a second mapping of light settings to the light sources is determined in step 131. This second mapping instruction is determined based on the second spatial distribution.

The mapping instruction may specify a light setting per light source for only a subset of the light sources, a light effect transition speed per light source for all of the light sources, a light effect transition speed per light source for only a subset of the light sources, a light effect rendering probability per light source for all of the light sources, a light effect rendering probability per light source for only a subset of the light sources, or multiple groups of the light sources, for example. In the latter case, each of the multiple groups renders a different light setting and all light sources of a single group rendering a same light setting.

A step 133 is performed by the controller 41. Step 133 comprises transmitting, the mapping instruction determined in step 131 and a command to render the light effect on the light string to the light string 1. The command specifies one or more colors and/or one or more light intensities. The mapping instruction and the command may be transmitted separately or together. For example, the mapping instruction may be included in the command. A step 135 is performed by the light string 1. Step 135 comprises receiving the mapping instruction and the command from the controller 41.

A step 137 is performed by the light string 1. Step 137 comprises determining a mapping based on the one or more colors and/or the one or more light intensities specified in the command and further based on the mapping instruction. This mapping is thus based on the spatial distribution specified in the input signal received by the controller 41. If the first mapping instruction was received in step 135, a first mapping is determined in step 137. This first mapping corresponds to a non-linear or other unequal light setting distribution over the light sources. This first mapping may be determined if the object is cone-shaped or sphere-shaped or hourglass-shaped, for example.

If the second mapping instruction was received in step 135, a second mapping is determined in step 137. This second mapping corresponds to a linear or other equal light setting distribution over the light sources. This second mapping may be determined if the second object is cylinder-shaped or rectangle-shaped, for example. Step 107 comprises controlling the light sources to render the light settings according to the mapping determined in step 137. Additionally, steps 151 and 153 of the embodiment of FIG. 6 may be added to the embodiment of FIG. 4.

A fourth embodiment of the method of controlling a plurality of individually controllable light sources of a light string is shown in FIG. 6. The fourth embodiment of FIG. 6 is an extension of the first embodiment of FIG. 3. In the embodiment of FIG. 6, a step 151 is performed between steps 101 and 103 of FIG. 3 and step 105 of FIG. 3 is implemented by a step 153.

Step 151 comprises obtaining information indicative of an accuracy of the first spatial distribution and/or a reliability of the first spatial distribution. Step 153 comprises determining the first mapping and/or a level of dynamicity of the light effect based on the accuracy and/or the reliability indicated in the information obtained in step 151. Step 107 comprises controlling, at the light string, the light sources to render the light settings according to the first mapping. If a level of dynamicity is determined in step 153, the light sources are controlled in step 107 according to the level of dynamicity determined in step 153.

If the spatial distribution is not (very) accurate (e.g. the object size is unknown or further configuration parameters are unknown), aspects of the light effect may be masked to minimize apparent artefacts. This masking may be achieved, for example, by reducing the level of dynamicity of the light effect and/or by adjusting the mapping to reduce differences between light settings of successive light sources. The level of dynamicity may be reduced, for example, by reducing how often a light source can render a different light setting. The mapping may be adjusted, for example, by increasing smoothing parameters or by increasing the pixel size of effects (i.e. by using larger groups that render the same light setting), thereby making spatial effects less apparent. Not only spatial smoothing may be increased, but also temporal smoothing (which causes smaller differences between successive light settings rendered by the same light source).

Additionally, one or more steps of the embodiment of FIG. 4 or the embodiment of FIG. 5 may be added to the embodiment of FIG. 6. In an extension of the embodiment of FIG. 5, step 151 is performed by the light string 1. In an extension of the embodiment of FIG. 6, step 151 is performed by the controller 41.

FIG. 7 depicts a block diagram illustrating an exemplary data processing system that may perform the method as described with reference to FIGS. 3-6.

As shown in FIG. 7, the data processing system 300 may include at least one processor 302 coupled to memory elements 304 through a system bus 306. As such, the data processing system may store program code within memory elements 304. Further, the processor 302 may execute the program code accessed from the memory elements 304 via a system bus 306. In one aspect, the data processing system may be implemented as a computer that is suitable for storing and/or executing program code. It should be appreciated, however, that the data processing system 300 may be implemented in the form of any system including a processor and a memory that is capable of performing the functions described within this specification. The data processing system may be an Internet/cloud server, for example.

The memory elements 304 may include one or more physical memory devices such as, for example, local memory 308 and one or more bulk storage devices 310. The local memory may refer to random access memory or other non-persistent memory device(s) generally used during actual execution of the program code. A bulk storage device may be implemented as a hard drive or other persistent data storage device. The processing system 300 may also include one or more cache memories (not shown) that provide temporary storage of at least some program code in order to reduce the quantity of times program code must be retrieved from the bulk storage device 310 during execution. The processing system 300 may also be able to use memory elements of another processing system, e.g. if the processing system 300 is part of a cloud-computing platform.

Input/output (I/O) devices depicted as an input device 312 and an output device 314 optionally can be coupled to the data processing system. Examples of input devices may include, but are not limited to, a keyboard, a pointing device such as a mouse, a microphone (e.g. for voice and/or speech recognition), or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 7 with a dashed line surrounding the input device 312 and the output device 314). An example of such a combined device is a touch sensitive display, also sometimes referred to as a “touch screen display” or simply “touch screen”. In such an embodiment, input to the device may be provided by a movement of a physical object, such as e.g. a stylus or a finger of a user, on or near the touch screen display.

A network adapter 316 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 300, and a data transmitter for transmitting data from the data processing system 300 to said systems, devices and/or networks. Modems, cable modems, and Ethernet cards are examples of different types of network adapter that may be used with the data processing system 300.

As pictured in FIG. 7, the memory elements 304 may store an application 318. In various embodiments, the application 318 may be stored in the local memory 308, the one or more bulk storage devices 310, or separate from the local memory and the bulk storage devices. It should be appreciated that the data processing system 300 may further execute an operating system (not shown in FIG. 7) that can facilitate execution of the application 318. The application 318, being implemented in the form of executable program code, can be executed by the data processing system 300, e.g., by the processor 302. Responsive to executing the application, the data processing system 300 may be configured to perform one or more operations or method steps described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 302 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration, but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A lighting system comprising a light string and a controller for controlling said light string, said controller comprising at least one receiver at least one transmitter and at least one processor and said light string comprising a plurality of individually controllable light sources at least one further receiver and at least one further processor
said at least one processor of said controller being configured to transmit, via said at least one transmitter to said light string, a command to render a light effect on said light string, said command specifying one or more colors and/or one or more light intensities, and wherein said light effect comprises a temporal light setting distribution and
said at least one further processor of said light string being configured to receive said command via said at least one further receiver, determine, in response to said command, a first mapping of light settings to said light sources based on said one or more colors and/or said one or more light intensities, and control said light sources to render said light settings according to said first mapping,
wherein said at least one processor or said at least one further processor is configured to receive a first input signal, said first input signal specifying a first spatial distribution, said first spatial distribution indicating first locations of said light sources with respect to an object, and said at least one further processor is configured to determine said first mapping further based on said first spatial distribution such that a light effect transition speed per light source or a light effect rendering probability per light source depends on said first spatial distribution.

2. A lighting system as claimed in claim 1, wherein said at least one further processor is configured to determine said first mapping further based on said first spatial distribution, said first mapping corresponding to a non-linear or other unequal light setting distribution over said light sources

3. A lighting system as claimed in claim 2, wherein said at least one processor or said at least one further processor is configured to receive a second input signal, said second input signal specifying a second spatial distribution, said second spatial distribution indicating second locations of said light sources with respect to a second object, and
said at least one further processor is configured to determine a second mapping of light settings to said light sources (based on said one or more colors and/or said one or more light intensities and further based on said second spatial distribution, said second mapping corresponding to a linear or other equal light setting distribution over said light sources, and control said light sources to render said light settings according to said second mapping.

4. A lighting system as claimed in claim 2, comprising a further light string, said further light string comprising another plurality of individually controllable light sources at least one other receiver and at least one other processor configured to:
receive, via said at least one other receiver a further command to render said light effect on said further light string, said further command specifying said one or more colors and/or said one or more light intensities,
determine, in response to said further command, a further mapping of light settings to said other light sources based on said one or more colors and/or said one or more light intensities, said further mapping corresponding to a linear or other equal light setting distribution over said other light sources, and
control said other light sources to render said light settings according to said further mapping.

5. A lighting system as claimed in claim 1, wherein said first spatial distribution is represented by at least one of: the shape of said light string with respect to said object, the shape of said object, and a quantity of light sources per part of said object and said at least one further processor is configured to determine said first mapping based on at least one of: said shape of said light string-{1}, said shape of said object, and said quantity of light sources per part of said object.

6. A lighting system as claimed in claim 1, wherein said one or more colors comprise a plurality of colors, said light effect comprises a spatial color distribution, and said at least one further processor is configured to determine said first mapping based on said plurality of colors and said first spatial distribution, said first mapping corresponding to a non-linear color distribution over said light sources.

7. A lighting system as claimed in claim 6, wherein said light effect is a color gradient light effect.

8. A lighting system as claimed in claim 1, wherein said light effect is a sparkle effect or a blink effect.

9. A lighting system as claimed in claim 1, wherein said object is cone-shaped or sphere-shaped or hourglass-shaped.

10. A lighting system as claimed in claim 1,
wherein said at least one processor or said at least one further processor is configured to obtain information indicative of an accuracy of said first spatial distribution and/or a reliability of said first spatial distribution, and
said at least one further processor is configured to determine said first mapping and/or a level of dynamicity of said light effect based on said accuracy and/or said reliability.

11. A light string for use in the lighting system of claim 1, wherein said light string comprises said plurality of individually controllable light sources said at least one further receiver, and said least one further processor, and said at least one further processor is configured to:
receive said first input signal, said first input signal specifying said first spatial distribution, said first spatial distribution indicating said first locations of said light sources with respect to said object,
receive said command via said at least one further receiver,
determine, in response to said command, said first mapping of light settings to said light sources based on said one or more colors and/or said one or more light intensities and further based on said first spatial distribution such that a light effect transition speed per light source or a light effect rendering probability per light source depends on said first spatial distribution, and
control said light sources to render said light settings according to said first mapping.

12. A controller for use in the lighting system of claim 1, wherein said controller comprises said at least one receiver said at least one transmitter and said least one processor and said at least one processor is configured to:
receive said first input signal, said first input signal specifying said first spatial distribution, said first spatial distribution indicating said first locations of said light sources of said light string with respect to said object,
determine a first mapping instruction for said light string based on said first spatial distribution, and
transmit, via said at least one transmitter to said light string, said first mapping instruction and said command to render said light effect on said light string to cause said at least one further processor of said light string to determine said first mapping based on said one or more colors and/or said one or more light intensities and further based on said first spatial distribution such that a light effect transition speed per light source or a light effect rendering probability per light source depends on said first spatial distribution.

13. A method of controlling a plurality of individually controllable light sources of a light string, said method comprising:
receiving a first input signal, said first input signal specifying a first spatial distribution, said first spatial distribution indicating first locations of said light sources with respect to an object;
transmitting, from a controller to said light string, a command to render a light effect on said light string, said command specifying one or more colors and/or one or more light intensities;
determining, at said light string, in response to said command, a first mapping of light settings to said light sources based on said one or more colors and/or said one or more light intensities and further based on said first spatial distribution such that a light effect transition speed per light source or a light effect rendering probability per light source depends on said first spatial distribution; and
controlling, at said light string, said light sources to render said light settings according to said first mapping.

14. A computer program product for a computing device, the computer program product comprising computer program code to perform the method of claim 13 when the computer program product is run on a processing unit of the computing device.
